(19) United States
(12) Patent Application Publication
(10) Pub. No.: US 2024/0377457 A1
(43) Pub. Date: Nov. 14, 2024

(54) BATTERY THERMAL RUNAWAY PREDICTION METHOD AND APPARATUS, AND COMPUTER-READABLE STORAGE MEDIUM

(71) Applicant: SVOLT ENERGY TECHNOLOGY CO., LTD., Changzhou, Jiangsu (CN)

(72) Inventors: Weidong HU, Changzhou (CN); Maofan WANG, Changzhou (CN); Chaoshuai HU, Changzhou (CN); Yajie XU, Changzhou (CN)

(73) Assignee: SVOLT ENERGY TECHNOLOGY CO., LTD., Changzhou, Jiangsu (CN)

(21) Appl. No.: 18/691,012

(22) PCT Filed: May 24, 2022
(86) PCT No.: PCT/CN2022/094746

§ 371 Date: Mar. 11, 2024

(30) Foreign Application Priority Data
Sep. 10, 2021 (CN) 202111058590.X

(51) Int. Cl. G01R 31/36; G01R 31/3842

(52) U.S. Cl. CPC G01R 31/3648; G01R 31/3842

(57) ABSTRACT

Disclosed are a battery thermal runaway prediction method and apparatus, and a computer-readable storage medium. The battery thermal runaway prediction method includes: when a hot box temperature T, a battery self-heating starting temperature T1 and a thermal runaway starting temperature T2 satisfy T1<T<T2, if a battery self-heating rate K₁ is greater than a rate K₂ of heat transfer from a hot box to an interior of a battery, thermal runaway occurring at a surface of the battery first; and if the battery self-heating rate K₁ is less than the rate K₂ of heat transfer from the hot box to the interior of the battery, thermal runaway occurring first when self-produced heat inside the battery accumulates to a limit value, and thermal runaway not occurring when the self-produced heat inside the battery has not accumulated to the limit value. The battery thermal runaway prediction method can replace a hot box test method to effectively assess safety of a battery and accurately acquire a safe boundary of a battery hot box test. Besides, test cost is low, and a test period is short.

The present disclosure claims priority to patent application No. 202111058590.X, filed with the Chinese Patent Office on Sep. 10, 2021, entitled “Battery Thermal Runaway Prediction Method and Apparatus, and Computer-Readable Storage Medium”, the entire contents of which are incorporated by reference into the present disclosure.

### TECHNICAL FIELD

The present invention relates to the technical field of battery processing, in particular to a battery thermal runaway prediction method. Meanwhile, the present invention further relates to an apparatus for executing the battery thermal runaway prediction method, and a computer-readable storage medium storing a program capable of executing the battery thermal runaway prediction method.

### BACKGROUND

A lithium-ion battery is a secondary battery that is currently attracting much attention due to its high energy density, long cycle life and environmental safety and other advantages. However, with wide application of lithium-ion batteries, battery safety accidents occur from time to time, and safety problems of lithium-ion batteries have attracted more and more attention. Therefore, it is necessary to clearly understand limits that batteries can withstand in the case of abuse.

The abuse of lithium-ion batteries is mainly divided into thermal abuse, mechanical abuse and electrical abuse. Difficulties of passing different safety test items are different, and it is generally believed that needling, overcharging, hot box and short circuit are abuse tests which are more difficult to pass.

The safety of a lithium-ion battery can generally be assessed from a material level and a cell level, and thermal stability of a material is difficult to truly and accurately reflect safety of a cell. At present, a hot box is often used to simulate a battery or an instrument with a battery in a very hot environment, and an endurance limit of the battery is tested by gradually increasing the temperature. This test process is called a hot box test.

However, in the prior art, a hot box test can only assess whether a battery can pass the test at a certain temperature, that is, the hot box test can only assess safety of the battery at a certain temperature, but cannot know a safety boundary of the hot box. In the hot box test process, the larger a capacity of the lithium-ion battery is, the greater damage to the device is, the higher test cost and battery manufacturing cost are, and the longer a test period and a battery manufacturing period are. Besides, the hot box test is difficult to meet requirements of repeated tests under a condition of a small amount of samples.

### SUMMARY OF THE INVENTION

In view of the above, the present disclosure aims to provide a battery thermal runaway prediction method, which can replace a hot box test method and effectively assess safety of a battery.

In order to achieve the above objectives, the technical solutions of the present disclosure are implemented as follows.

A battery thermal runaway prediction method includes: when a hot box temperature T, a battery self-heating starting temperature T1 and a thermal runaway starting temperature T2 satisfy T1<T<T2: if a battery self-heating rate K₁ is greater than a rate K₂ of heat transfer from a hot box to an interior of a battery, thermal runaway occurs at a surface of the battery first; and if the battery self-heating rate K₁ is less than the rate K₂ of heat transfer from the hot box to the interior of the battery, thermal runaway occurs first when self-produced heat inside the battery accumulates to a limit value, and thermal runaway does not occur when the self-produced heat inside the battery has not accumulated to the limit value.

Further, the battery self-heating rate is K₁=Σₓ^{y}{Aₓ×e^{-E}^{_{a,x}}^{/RT}^{ₓ}×f(aₓ)}, where: Aₓ is a pre-exponential factor; E_{a,x} is activation energy of a reaction; R is a molar gas constant; Tₓ is a peak temperature; f(aₓ) is a reaction mechanism function; x is a lower limit value of a peak sorting of a DSC test curve, and y is an upper limit value of the peak sorting of the DSC test curve.

Further, the reaction mechanism function is f(aₓ)=(1−aₓ)ⁿ(1+K_{cat}aₓ), where: n is a reaction order, K_{cat} is a catalytic coefficient, and aₓ is a proportion of reactants participating in an autocatalytic reaction.

Further, the battery self-heating rate K₁ is obtained by respectively carrying out a DSC test according to a positive electrode and a negative electrode, a positive electrode and an electrolyte, and a negative electrode and an electrolyte, then carrying out kinetic parameter fitting, respectively calculating self-heating rates of the three, and then summing the self-heating rates of the three.

Further, the DSC test includes steps: S1, charging a battery to a full state of charge by 1/3C CC-CV (Constant Current/Constant Voltage), and then disassembling the battery; S2, soaking and cleaning positive and negative electrode pieces obtained by disassembling, and then drying the positive and negative electrode pieces; S3, punching and cutting the positive and negative electrode pieces in step S2 to obtain a plurality of electrode pieces with a diameter of D, and then placing part of the electrode pieces in the electrolyte to make test samples with components being positive electrode, negative electrode, electrolyte, positive electrode+electrolyte, negative electrode+electrolyte, positive electrode+negative electrode, and positive electrode+negative electrode+electrolyte respectively; and S4, performing the DSC test on each test sample in step S3, and changing an ambient temperature of each test sample at a different heating rate during the test.

Further, in step S2, DMC (dimethyl carbonate) is used as a solvent for soaking and cleaning, and/or, soaking and cleaning are carried out for 3 times, and/or, each soaking lasts for 5 minutes, and/or, the positive electrode piece obtained by disassembling is dried in a vacuum environment at 60° C.

Further, in step S3, the diameter D is 5 mm, and/or, a number of the punched and cut positive and negative electrode pieces is more than or equal to 4.

Further, in step S4, temperatures before and after the heating are 25° C. and 450° C., respectively, and/or, the heating rates are 5° C./min, 10° C./min, 15° C./min, or 20° C./min, respectively.

Further, the rate of heat transfer from the hot box to the interior of the battery is

$${K}_{2} = {\sum }_{i}^{m} \frac{{k}_{i} {d}_{i}}{d} ,$$

where: kᵢ is a thermal conductivity of each component of the battery; dᵢ is a thickness of each component of the battery; d is a total thickness of an inner electrode group of the battery; i is a lower limit value of a number of component types of the battery; and m is an upper limit value of a number of the component types of the battery.

Further, the components of the battery includes: a positive electrode coating, a positive electrode current collector, a diaphragm, a negative electrode coating, a negative electrode current collector, an electrolyte and an aluminum shell.

Further, when the hot box temperature T and the battery self-heating starting temperature T1 satisfy T<T1, battery thermal runaway does not occur.

Further, when the hot box temperature T and the thermal runaway starting temperature T2 satisfy T>T2, thermal runaway occurs at a surface of the battery first.

Further, the battery self-heating starting temperature T1 is decided by the battery self-heating rate ≥0.02° C./min; and/or, the thermal runaway starting temperature T2 is decided by the battery self-heating rate >1° C./min.

A battery thermal runaway prediction apparatus includes a battery thermal runaway prediction device and a computer, wherein the computer includes a memory and a processor, a computer program is stored in the memory, and the computer program, when run on the processor, executes the battery thermal runaway prediction method of the present disclosure.

A computer-readable storage medium stores a computer program. The computer program, when run on a processor, executes the battery thermal runaway prediction method of the present disclosure.

Compared with the prior art, the present disclosure has the following advantages:

The battery thermal runaway prediction method disclosed by the present disclosure, by comparing the battery self-heating rate K₁ and the rate K₂ of heat transfer from the hot box to the interior of the battery and acquiring the limit value of the self-generated heat accumulated inside the battery, can replace the hot box test method to assess the safety of the battery and accurately acquire the safety boundary of the battery hot box test, and further realize characterization of the safety of the battery. Besides, the test cost and period can be saved, and the requirements of repeated tests can be met under the condition of a small amount of samples, and the method is quick, simple and effective.

### BRIEF DESCRIPTION OF THE DRAWINGS

The accompanying drawings, which are incorporated in and constitute a part of the present disclosure, are included to provide a further understanding of the present disclosure, the illustrative embodiment of the present disclosure and the description thereof are for the purpose of illustrating the present disclosure, and are not to be construed as unduly limiting the present disclosure. In the accompanying drawings:

FIG. 1 is a DSC test curve chart of each component in the battery according to an embodiment of the present disclosure;

FIG. 2 is a comparison chart of DSC test results of heat production of each component in the battery according to an embodiment of the present disclosure;

FIG. 3 is a comparison chart of results of kinetic parameter fitting data according to an embodiment of the present disclosure; and

FIG. 4 is a comparison chart of thermal conductivity data of each component in the battery according to an embodiment of the present disclosure.

### DETAILED DESCRIPTION

It should be noted that embodiments in the present disclosure and features in the embodiments can be combined with each other without conflicts.

The present disclosure will be described in detail below with reference to the accompanying drawings and in conjunction with the embodiments.

This embodiment relates to a battery thermal runaway prediction method. The method includes: when a hot box temperature T, a battery self-heating starting temperature T1 and a thermal runaway starting temperature T2 satisfy T1<T<T2: if a battery self-heating rate K₁ is greater than a rate K₂ of heat transfer from a hot box to an interior of a battery, thermal runaway occurring at a surface of the battery first. If the battery self-heating rate K₁ is less than the rate K₂ of heat transfer from the hot box to the interior of the battery, thermal runaway occurs first when self-produced heat inside the battery accumulates to a limit value, and thermal runaway does not occur when the self-produced heat inside the battery has not accumulated to the limit value.

It should be noted that the above hot box temperature is a temperature simulating a working environment of the battery. The battery self-heating starting temperature T1 is determined by the battery self-heating rate ≥0.02° C./min. The thermal runaway starting temperature T2 is determined by the battery self-heating rate >1° C./min.

In specific implementation, the battery self-heating rate in this embodiment is

$${K}_{1} = {\sum }_{x}^{y} \{ {A}_{x} \times {e}^{\frac{- {E}_{a , x}}{{RT}_{x}}} \times f ( {α}_{x} ) \} ,$$

where: Aₓ is a pre-exponential factor; E_{a,x} is activation energy of a reaction; R is a molar gas constant; Tₓ is a peak temperature; f(aₓ) is a reaction mechanism function; x is a lower limit value of a peak sorting of a DSC test curve, and y is an upper limit value of the peak sorting of the DSC test curve.

It should be noted here that the peak sorting refers to distinguishing the amount of peaks in the DSC test curve, and then sorting all peaks from 1, which can be called the first peak, the second peak, and the y-th peak, x=1, 2 . . . y. Parameters such as Aₓ, E_{a,x}, Tₓ and aₓ correspond to values of the peaks, and the parameters will change accordingly if the values of the peaks are different, which can be determined in a process of fitting the DSC test curve.

Besides, the battery self-heating rate K₁ is obtained by respectively carrying out a DSC (Differential Scanning calorimetry) test according to positive electrode and negative electrode, positive electrode and electrolyte, and negative electrode and electrolyte, then carrying out kinetic parameter fitting, respectively calculating self-heating rates of the three, and then summing the self-heating rates of the three.

The reaction mechanism function is f(aₓ)−(1−aₓ)ⁿ(1+K_{cat}aₓ), where: n is a reaction order, K_{cat} is a catalytic coefficient, and ax is a proportion of reactants participating in an autocatalytic reaction. Apparently, the reaction mechanism function f(aₓ)−(1−aₓ)ⁿ(1+K_{cat}aₓ) is not fixed, and batteries of different systems further correspond to different reaction mechanism functions in the case of fitting.

In specific implementation, in this embodiment, the rate of heat transfer from the hot box to the interior of the battery is

$${K}_{2} = {\sum }_{i}^{m} \frac{{k}_{i} {d}_{i}}{d} ,$$

where: kᵢ is a thermal conductivity of each component of the battery; dᵢ is a thickness of each component of the battery; d is a total thickness of an inner electrode group of the battery; i is a lower limit value of a number of component types of the battery; and m is an upper limit value of a number of the component types of the battery. The components of the battery includes: a positive electrode coating, a positive electrode current collector, a diaphragm, a negative electrode coating, a negative electrode current collector, an electrolyte and an aluminum shell.

In this embodiment, when the hot box temperature T and the battery self-heating starting temperature T1 satisfy T<T1, battery thermal runaway does not occur. Besides, when the hot box temperature T and the thermal runaway starting temperature T2 satisfy T>T2, thermal runaway occurs at a surface of the battery first.

The method of the present disclosure is further described below based on a specific test to verify feasibility of the method of the present disclosure. Firstly, each component of the battery is subjected to a DSC test, three items with the maximum heat release are selected to test at different heating rates, data obtained from the test is fitted to obtain kinetic parameters, and then self-heating rates are calculated. The specific test process and test parameters are as follows:

S1. Charge a battery to a full state of charge by 1/3C CC-CV (Constant Current/Constant Voltage), and then disassemble the battery in a glove box.

S2. Soak and clean positive and negative electrode pieces obtained by disassembling with DMC (dimethyl carbonate) for three times and 5 min each time, and then air the positive and negative electrode pieces in the glove box, where, the positive electrode piece needs to be baked in vacuum at 60° C., and then packaged into a aluminum-plastic film, while the negative electrode piece does not need additional conditions, and is aired at a room temperature in the glove box, and then packaged into the aluminum-plastic film.

It should be noted that DMC (dimethyl carbonate) is an organic compound with a chemical formula of C₃H₆O₃. DMC has excellent solubility and low boiling point characteristics. In practical applications, in addition to using the DMC to soak and clean the positive and negative electrode pieces, other organic solvents with low boiling points can also be used, such as DEC (diethyl carbonate).

S3. Make a sample in the glove box, punch and cut a plurality of electrode pieces (including at least four positive electrode pieces and four negative electrode pieces) with a diameter of D (a value of D can be changed according to an actual design requirement, and the diameter of 5 mm is selected for this test), and take out a plurality of steel crucibles;
then, put the plurality of electrode pieces into the steel crucibles respectively, and put 2 μL of electrolyte into part of the steel crucibles to make test samples with components being positive electrode, negative electrode, electrolyte, positive electrode+electrolyte, negative electrode+electrolyte, positive electrode+negative electrode, and positive electrode+negative electrode+electrolyte.

S4. Perform the DSC test on each test sample in step S3, and change a temperature of each test sample at a different heating rate during the test from 25° C. to 450° C., where the heating rates are 5° C./min, 10° C./min, 15° C./min, or 20° C./min, respectively.

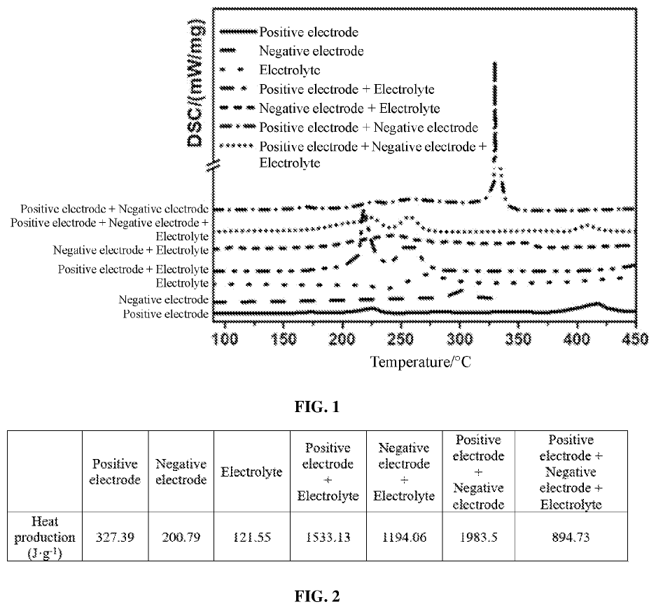

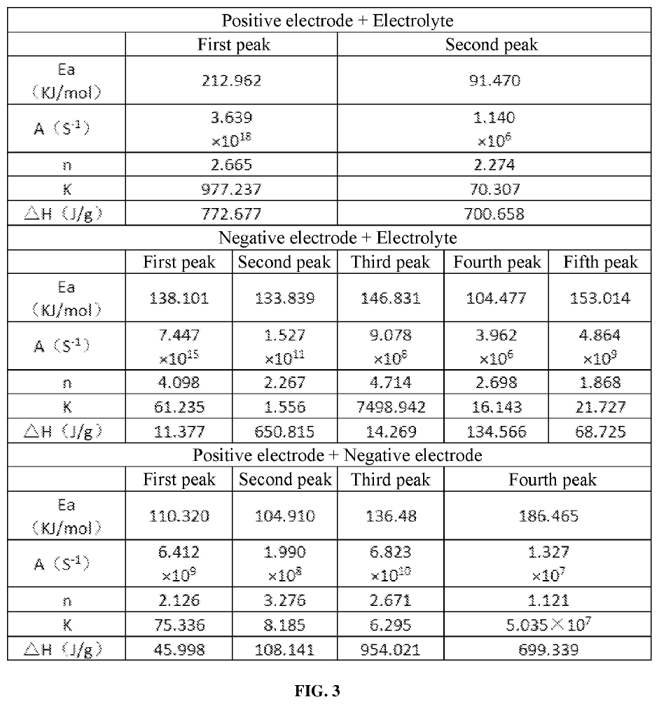

Test results are shown in FIGS. 1 to 4, in which FIG. 1 shows a DSC test curve of each component in the battery, a horizontal axis being a temperature, and a vertical axis being a heat release. Referring to FIG. 1, when a temperature in the horizontal axis is 100° C., test samples characterized by curves in the figure sequentially from bottom to top are positive electrode, negative electrode, electrolyte, positive electrode+electrolyte, negative electrode+electrolyte, positive electrode+negative electrode, and positive electrode+negative electrode+electrolyte. FIG. 2 is a comparison chart of DSC test results of heat production of each component in the battery, from which it can be seen that the test samples of positive electrode+electrolyte, negative electrode+electrolyte and positive electrode+negative electrode have the highest heat production.

Therefore, these three items are selected for kinetic parameter fitting, that is, the reaction mechanism function f(aₓ)=(1−aₓ)ⁿ(1+K_{cat}aₓ) is used for calculation to obtain the fitting results shown in FIG. 3. Now, the test result of positive electrode+electrolyte in FIG. 3 is selected to calculate the self-heating rate of the battery:

$${K}_{positive electrode + electrolyte} = {K}_{positive electrode + electrolyte - 1} + {K}_{positive electrode + electrolyte - 2} = \{ 3.639 \times 1 {0}^{18} \times e \hat{} [ ( - 212962 ) / ( 8.314 \times 491.47 ) ] \times {( 1 - 0.39 )}^{2.665} \times ( 1 + 977.237 \times 0.39 ) \} + \{ 1.14 \times 1 {0}^{6} \times e \hat{} [ ( - 91470 ) / ( 8.314 \times 53 \; 0.413 ) ] \times {( 1 - 0.61 )}^{2.274} \times ( 1 + 70.307 \times 0.61 ) \} = 14.4$$

where, 3.639×10¹⁸ and 1.14×10⁶ are pre-exponential factors of the corresponding positive electrode+electrolyte test samples in FIG. 3;
212962 and 91470 are activation energies of reactions in FIG. 3 for the positive electrode+electrolyte test samples;
8.314 is a molar gas constant R; 491.47 and 530.413 are hot box temperatures T;
(1−0.39)^{2.665}×(1+977.237×0.39) and (1−0.61)^{2.274}×(1+70.307×0.61) are reaction mechanism functions f(aₓ);
0.39 and 0.61 are aₓ, which are obtained by fitting kinetic parameters using NETZSCHKineticsNeo software (NETZSCH thermal kinetics software).

In the same way, K_{negative electrode+electrolyte}=11.26; and K_{positive electrode+negative electrode}=11.02.

Therefore, the total self-heating rate of the battery is K₁=14.4+11.26+11.02=36.68.

At this time, the internal heat transfer rate of the battery is calculate by the heat transfer rate formula

$${K}_{2} = {\sum }_{i}^{m} \frac{{k}_{i} {d}_{i}}{d} ,$$

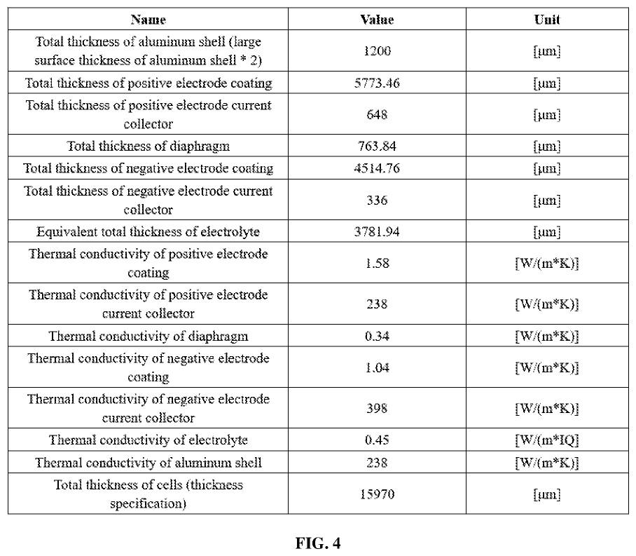

and according to the thermal conductivity of each component in the battery in FIG. 4, and the thickness dᵢ of each component and the total thickness d of the electrode group in the battery tested by a conventional means.

As can be seen from comparison between the total battery self-heating rate K₁ and the rate K₂ of heat transfer in the battery, due to K₁<K₂, thermal runaway occurs first when self-produced heat inside the battery accumulates to a limit value, and thermal runaway does not occur when the self-produced heat inside the battery has not accumulated to the limit value. Therefore, on the basis of the total battery self-heating rate K₁ and the heat transfer rate K₂ obtained by calculation, the safety of the battery can be characterized, and K₁ can also be used to accurately characterize the safety boundary of the battery hot box test.

To sum up, a way to characterize the safety of the battery and the safety boundary in this embodiment is specifically as follows:
A. When T<T1, the battery can work safely without thermal runaway, and at this time, T1 is used to characterize the safety boundary at which the battery can work safely.
B. When T>T2, the battery can not work, thermal runaway occurs at the surface thereof first, and at this time, T2 is used to characterize to exceed the safety operation boundary of the battery.
C. When T1<T<T2, K₁ and K₂ need to be calculated; if K₁>K₂, thermal runaway occurs at the surface of the battery first, and at this time, T is used to characterize to exceed the safety operation boundary of the battery; and if K₁<K₂, T/K₁=h (working time), a working time of the battery at the temperature T can be calculated, and at this time, T and h are together used to characterize the safety operation boundary of the battery.

The battery thermal runaway prediction method of this embodiment, by comparing the battery self-heating rate K₁ and the rate K₂ of heat transfer from the hot box to the interior of the battery and acquiring the limit value of the self-generated heat accumulated inside the battery, can replace the hot box test method to assess the safety of the battery and accurately acquire the safety boundary of the battery hot box test, and further realize characterization of the safety of the battery. Besides, the test cost and period can be saved, and the requirements of repeated tests can be met under the condition of a small amount of samples, and the method is quick, simple and effective.

This embodiment further provides a battery thermal runaway prediction apparatus, including a battery thermal runaway prediction device and a computer. The computer includes a memory and a processor, a computer program is stored in the memory, and the computer program, when run on the processor, executes the battery thermal runaway prediction method in this embodiment.

In addition, this embodiment further provides a computer-readable storage medium, in which a computer program is stored. The computer program, when run on the processor, executes the battery thermal runaway prediction method in this embodiment.

Those skilled in the art may understand that implementation of all or part of the process of the method of the above embodiment is accomplished by the computer program or instruction-related hardware. The computer program may be stored in a computer-readable storage medium, and when executed, the program may include the process of the above embodiment of each above method. Any reference to a memory, a processor, a computer program, or other medium used in the embodiments presented herein may include a non-volatile and/or volatile memory.

The non-volatile memory can include a read only memory (ROM), a programmable ROM (PROM), an electrically programmable ROM (EPROM), an electrically erasable programmable ROM (EEPROM), or a flash memory. The volatile memory may include a random access memory (RAM) or an external cache memory.

Apparently, the RAM may be obtained in a variety of forms, such as a static RAM (SRAM), a dynamic RAM (DRAM), a double data rate SDRAM (DDRSDRAM), a memory bus (Rambus) direct RAM (RDRAM), a synchronous DRAM (SDRAM), a direct Rambus dynamic RAM (DRDRAM), and a Rambus dynamic RAM (RDRAM).

The above description is only a preferred embodiment of the present disclosure, and is not intended to limit the present disclosure. Any modification, equivalent substitution, improvement, and the like within the spirit and principle of the present disclosure shall be included in the protection scope of the present disclosure.

1. A battery thermal runaway prediction method, comprising:
when a hot box temperature T, a battery self-heating starting temperature T1 and a thermal runaway starting temperature T2 satisfy T1<T<T2:
if a battery self-heating rate K₁ is greater than a rate K₂ of heat transfer from a hot box to an interior of a battery, thermal runaway occurring at a surface of the battery first; and
if the battery self-heating rate K₁ is less than the rate K₂ of heat transfer from the hot box to the interior of the battery, thermal runaway occurring first when self-produced heat inside the battery accumulates to a limit value, and thermal runaway not occurring when the self-produced heat inside the battery has not accumulated to the limit value.

2. The battery thermal runaway prediction method of claim 1, wherein:
the battery self-heating rate
$${K}_{1} = {\sum }_{x}^{y} \{ {A}_{x} \times {e}^{\frac{- {E}_{a , x}}{{RT}_{x}}} \times f ( {α}_{x} ) \} ,$$
wherein:
Aₓ is a pre-exponential factor;
E_{a,x} is activation energy of a reaction;
R is a molar gas constant;
Tₓ is a peak temperature;
f(aₓ) is a reaction mechanism function;
x is a lower limit value of a peak sorting of a DSC test curve, and
y is an upper limit value of the peak sorting of the DSC test curve.

3. The battery thermal runaway prediction method of claim 2, wherein:
the reaction mechanism function f(aₓ)=(1−aₓ)ⁿ(1+K_{cat}aₓ),
wherein:
n is a reaction order,
K_{cat} is a catalytic coefficient, and
aₓ is a proportion of reactants participating in an autocatalytic reaction.

4. The battery thermal runaway prediction method of claim 2, wherein:
the battery self-heating rate K₁ is obtained by respectively carrying out a DSC test according to a positive electrode and a negative electrode, a positive electrode and an electrolyte, and a negative electrode and an electrolyte,
then carrying out kinetic parameter fitting, respectively calculating self-heating rates of the three, and
then summing the self-heating rates of the three.

5. The battery thermal runaway prediction method of claim 4, wherein:
the DSC test comprises steps:
S1, charging a battery to a full state of charge by 1/3C CC-CV (Constant Current/Constant Voltage), and then disassembling the battery;
S2, soaking and cleaning positive and negative electrode pieces obtained by disassembling, and then drying the positive and negative electrode pieces;
S3, punching and cutting the positive and negative electrode pieces in step S2 to obtain a plurality of electrode pieces with a diameter of D, and then placing part of the electrode pieces in the electrolyte to make test samples with components being positive electrode, negative electrode, electrolyte, positive electrode+electrolyte, negative electrode+electrolyte, positive electrode+negative electrode, and positive electrode+negative electrode+electrolyte respectively; and
S4, performing the DSC test on each test sample in step S3, and changing an ambient temperature of each test sample at a different heating rate during the test.

6. The battery thermal runaway prediction method of claim 5, wherein:
in step S2, DMC (dimethyl carbonate) is used as a solvent for soaking and cleaning, and/or,
soaking and cleaning are carried out for 3 times, and/or, each soaking lasts for 5 minutes, and/or
the positive electrode piece obtained by disassembling is dried in a vacuum environment at 60° C.

7. The battery thermal runaway prediction method of claim 5, wherein:
in step S3, the diameter D is φ5 mm, and/or
a number of the punched and cut positive and negative electrode pieces is more than or equal to 4.

8. The battery thermal runaway prediction method of claim 5, wherein:
in step S4, temperatures before and after the heating are 25° C. and 450° C., respectively, and/or
the heating rates are 5° C./min, 10° C./min, 15° C./min, or 20° C./min, respectively.

9. The battery thermal runaway prediction method of claim 1, wherein:
the rate of heat transfer from the hot box to the interior of the battery is
$${K}_{2} = {\sum }_{i}^{m} \frac{{k}_{i} {d}_{i}}{d} ,$$
wherein:
kᵢ is a thermal conductivity of each component of the battery;
dᵢ is a thickness of each component of the battery;
d is a total thickness of an inner electrode group of the battery;
i is a lower limit value of a number of component types of the battery; and
m is an upper limit value of a number of the component types of the battery.

10. The battery thermal runaway prediction method of claim 9, wherein:
the components of the battery comprises:
a positive electrode coating,
a positive electrode current collector,
a diaphragm,
a negative electrode coating,
a negative electrode current collector,
an electrolyte, and
an aluminum shell.

11. The battery thermal runaway prediction method of claim 1, wherein:
when the hot box temperature T and the battery self-heating starting temperature T1 satisfy T<T1, battery thermal runaway does not occur.

12. The battery thermal runaway prediction method of claim 1, wherein:
when the hot box temperature T and the thermal runaway starting temperature T2 satisfy T>T2, thermal runaway occurs at a surface of the battery first.

13. The battery thermal runaway prediction method of claim 1, wherein:
the battery self-heating starting temperature T1 is determined by the battery self-heating rate ≥0.02° C./min; and/or
the thermal runaway starting temperature T2 is determined by the battery self-heating rate >1° C./min.

14. A battery thermal runaway prediction apparatus, comprising:
a battery thermal runaway prediction device, and
a computer, wherein:
the computer comprises a memory and a processor,
a computer program is stored in the memory, and
the computer program, when run on the processor, executes the battery thermal runaway prediction method of claim 1.

15. A non-transitory computer-readable storage medium, in which a computer program is stored, wherein the computer program, when run on a processor, executes the battery thermal runaway prediction method of claim 1.
